(19) United States
(12) Patent Application Publication
(10) Pub. No.: US 2024/0173732 A1
(43) Pub. Date: May 30, 2024

(54) SPRAYER HEAD HAVING INTEGRATED SECONDARY INTERNAL LIQUID RESERVOIR

(71) Applicant: Armis Biopharma, Inc., Fort Collins, CO (US)

(72) Inventor: Theodore Edwin Ziemann, Naples, FL (US)

(21) Appl. No.: 18/435,870

(22) Filed: Feb. 7, 2024

Related U.S. Application Data
(63) Continuation of application No. 18/251,791, filed on May 4, 2023.
(60) Provisional application No. 63/233,555, filed on Aug. 16, 2021.

(51) Int. Cl. B05B 11/10; B05B 12/14

(52) U.S. Cl. CPC B05B 11/1011; B05B 11/1081; B05B 12/1418

(57) ABSTRACT

A spray head for spraying a liquid mixture is provided. The spray head includes a spray reservoir configured to hold the liquid mixture, a channel configured to receive a first liquid into the spray reservoir, an internal liquid reservoir housed within the spray head, configured to hold a second liquid, and a dispenser configured to dispense the second liquid from the internal liquid reservoir to the spray reservoir. The liquid mixture is a mixture of the first liquid and the second liquid.

### CROSS-REFERENCE TO RELATED APPLICATIONS

This application is a continuation of U.S. patent application Ser. No. 18/251,791 filed May 4, 2023, which is a U.S. national phase application under 35 U.S.C. § 371 of International Patent Application No. PCT/US2022/074954 filed Aug. 15, 2022, which claims priority to U.S. Provisional Patent Application No. 63/223,555 filed Aug. 16, 2021, the disclosures of which are hereby incorporated by reference in their entireties.

### TECHNICAL FIELD

The present disclosure relates to spray-type liquid-dispensing apparatuses and, in particular, to sprayer heads configured to house a secondary reservoir for dispensing a liquid.

### BACKGROUND

Hand-powered spray bottle heads generally work by engaging a trigger mechanism to guide a liquid into the sprayer head from an exterior reservoir using, e.g., vacuum suction, and then, using the same trigger mechanism, spraying the liquid through a nozzle in the sprayer head. Generally, these sprayer heads are coupled to a tube which is inserted into the exterior liquid reservoir, and all of the liquid that is expelled from the nozzle is extracted from this exterior reservoir. This, however, poses a problem when multiple liquids are required or desired to be sprayed and mixed through the nozzle, since a single liquid stream is taken from the exterior liquid reservoir.

For example, many cleaning solutions or other liquids to be sprayed may have a foul or undesired odor. These liquids may not be able to be stored with a perfume or odor neutralizer for chemical or other reasons. In these instances, a perfume or odor neutralizer would have to be sprayed subsequent to the liquid from a separate spraying device. In addition to being ineffective in neutralizing the odor at the source, this increases the time needed to properly spray and deodorize the liquid and increases the number of spray bottles needed for a specific task. Additionally, given that these spray bottles are manually used, it may be difficult to accurately spray the perfume or odor neutralizer precisely in the same place that the liquid was sprayed, decreasing the effectiveness of the perfume or odor neutralizer.

For at least these reasons, a system and apparatus is needed which decreases the number of spray bottles and bottle sprayer heads needed to spray and perfume or deodorize a liquid, and which increases the effectiveness of accurately mixing the liquid with a perfume or deodorizer.

### SUMMARY

A spray head for spraying a liquid mixture is provided. The spray head includes a spray reservoir configured to hold the liquid mixture, a channel configured to receive a first liquid into the spray reservoir, an internal liquid reservoir housed within the spray head, configured to hold a second liquid, and a dispenser configured to dispense the second liquid from the internal liquid reservoir to the spray reservoir with a specific and precise ratio. The liquid mixture is a mixture of the first liquid and small volume of the second liquid.

According to various embodiments, the spray head further includes a nozzle and a trigger mechanism. The trigger mechanism is configured to force the liquid mixture from the spray reservoir to an exterior of the spray head through the nozzle.

According to various embodiments, the trigger mechanism is configured to be moved into a first position and a second position. According to various embodiments, the first position is when the trigger mechanism is pulled, and the second position is when the trigger mechanism is released. Releasing the trigger mechanism from the pulled position to the released position creates a vacuum on both reservoirs. The amount of liquid dispensed from the smaller reservoir in the sprayer head is designed to deliver a specific ratio of fluid to create the proper concentration as the mixed liquid discharges from the spray nozzle.

According to various embodiments, the sprayer further includes a measured liquid intake mechanism configured to limit a volume of liquid that is pulled from the internal liquid reservoir to the spray reservoir when the trigger mechanism moves from the first position to the second position.

According to various embodiments, the internal liquid reservoir includes a port through which the second liquid can flow, and the measured liquid intake mechanism includes a channel having an opening to the port.

According to various embodiments, the channel of the measured liquid intake mechanism has a first diameter, the opening has a second diameter, and the second diameter is smaller than the first diameter. According to various embodiments, the opening has a diameter of between 0.2 mm and 1.0 mm.

According to various embodiments, the dispenser includes a one-way valve configured to enable liquid to move from the internal liquid reservoir to the spray reservoir but not from the spray reservoir to the internal liquid reservoir. According to various embodiments, the one-way valve is a ball valve.

According to various embodiments, the internal liquid reservoir includes a vent valve positioned along an exterior of the spray head.

According to various embodiments, the channel configured to receive the first liquid includes a one-way valve configured to enable liquid to move through the channel in a direction toward the spray reservoir, but not in an opposing direction.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a side cross-sectional view of an example of a sprayer head, in accordance with various embodiments of the present disclosure;

FIG. 2 is a side view of an example of a sprayer head, in accordance with various embodiments of the present disclosure;

FIG. 3A is a perspective view of an example of an internal liquid dispenser and reservoir, in accordance with various embodiments of the present disclosure;

FIG. 3B is a side view of an example of an internal liquid dispenser and reservoir, in accordance with various embodiments of the present disclosure;

FIG. 4A is a perspective view of an example of an internal liquid dispenser, where a check valve is located, in accordance with various embodiments of the present disclosure;

FIG. 4B is a side cross-sectional view of an example of an internal liquid dispenser, where the check valve is located, in accordance with various embodiments of the present disclosure;

FIG. 5A is a perspective view of an example of a measured liquid intake mechanism and the seating surface for an internal ball-valve liquid dispenser, in accordance with various embodiments of the present disclosure;

FIG. 5B is a side cross-sectional view of an example of a measured liquid intake mechanism of an internal ball-valve sprayer, in accordance with various embodiments of the present disclosure;

FIG. 6A is a perspective view of an example of an internal liquid reservoir, in accordance with various embodiments of the present disclosure; and

FIG. 6B is a side cross-sectional view of an example of an internal liquid reservoir, in accordance with various embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are implicitly contemplated herein.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. When used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, the term “approximately,” when used in connection with a numeric value, is intended to include values that are close to, but not exactly, the number. For example, in some embodiments, the term “approximately” may include values that are within +/−10 percent of the value.

Other terms that are relevant to this disclosure are defined at the end of this Detailed Description section.

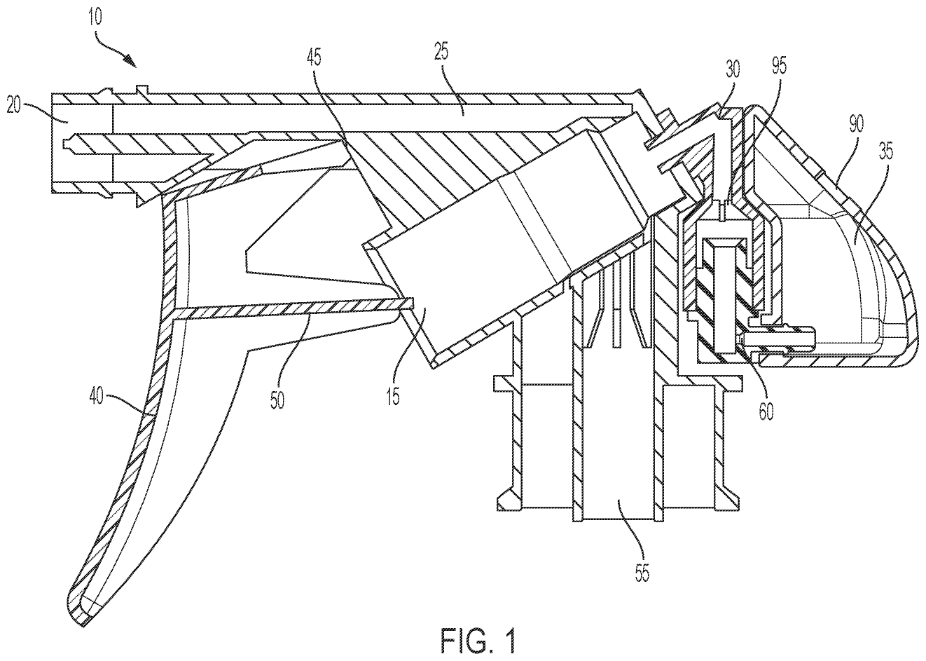

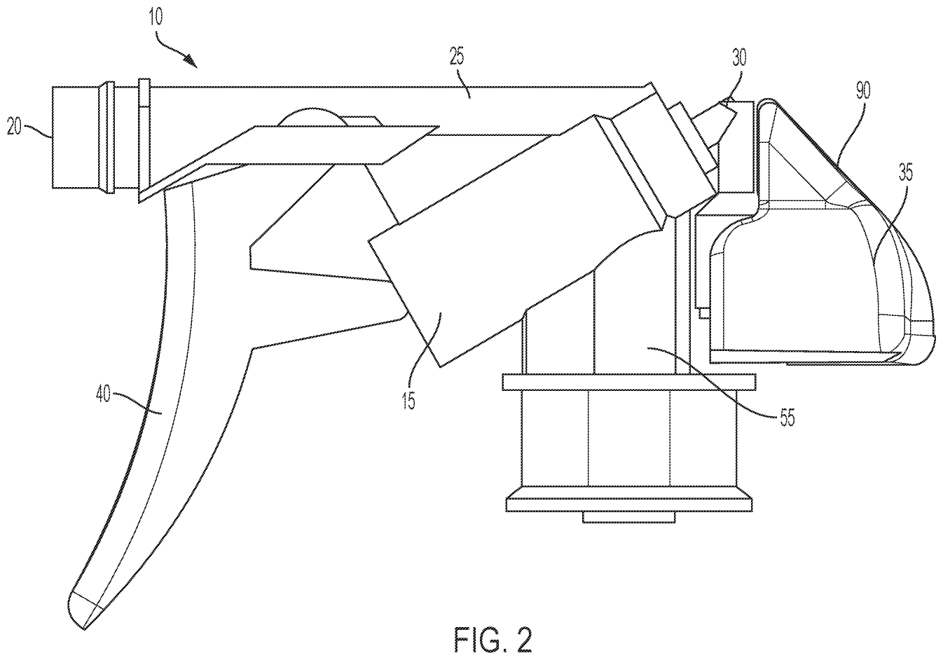

Referring now to FIGS. 1-2, a side cross-sectional view (FIG. 1) and a side view (FIG. 2) of a liquid sprayer head 10 are illustratively depicted.

According to various embodiments, the sprayer head 10 includes a spray reservoir 15 configured to store liquid to be sprayed through a nozzle 20 via a channel 25. The sprayer head 10 further includes an internal liquid dispenser 30 and reservoir 35. Additionally, the sprayer head 10 includes a trigger 40 configured to facilitate movement of liquid into the spray reservoir 15 and movement of liquid from the spray reservoir 15 through the nozzle 20 via channel 25.

The trigger 40 is configured to move between a pulled (first) position and a released (second) position. In the embodiment shown in FIGS. 1-2, the trigger 40 is in the released position. In the pulled position, the trigger 40 rotates around a rotation point or hinge 45, applying pressure to the spray reservoir 15 decreasing the interior volume of the spray reservoir 15. For example, the trigger 40 may include a protrusion 50 configured to enter the spray reservoir 15 and/or cause a plunger or other suitable device to enter the spray reservoir 15, decreasing the interior volume of the spray reservoir 15.

When liquid is within the spray reservoir while the trigger 40 is in the released position, when the trigger 40 is engaged and moved from the released position to the pulled position, the liquid in the spray reservoir 15 is forced from the spray reservoir 15, through a channel 25, and exterior from the spray head 10 via the nozzle 20. According to various embodiments, the nozzle 20 can include one or more holes of equal or varying size, configured to cause the liquid to escape from the spray head at a desired velocity.

According to various embodiments, the trigger 40 includes a biasing force (via, e.g., a spring or other suitable biasing member) configured to bias the trigger 40 from the pulled position to the released position upon removal of an external pressure from the trigger 40 (e.g., via the hand of a user). When the trigger 40 is released, the biasing member causes the trigger 40 to return the released position, increasing the internal volume of the spray reservoir 15. This increase in internal volume of the spray reservoir 15 results in a vacuum suction force within the spray reservoir 15, causing liquid to be sucked into the spray reservoir 15 through channel 55, from an exterior reservoir (not shown), and from the internal liquid reservoir 35. With the application of the vacuum suction force, liquid is pulled into the spray reservoir 15 from a plurality of sources.

Liquid enters the spray reservoir 15 from the exterior reservoir, through a channel 55, and into the spray reservoir 15. According to various embodiments, the spray reservoir 15 is coupled to the spray reservoir 15 via a one-way valve, enabling liquid to be sucked through the one-way valve with the application of the vacuum suction force within the spray reservoir 15, but prevents movement through the channel from the spray reservoir 15. According to various embodiments, the trigger is configured to cause an approximate volume of liquid to pass through the channel 55 into the spray reservoir 15 when the trigger 40 moves from the pulled position to the released position.

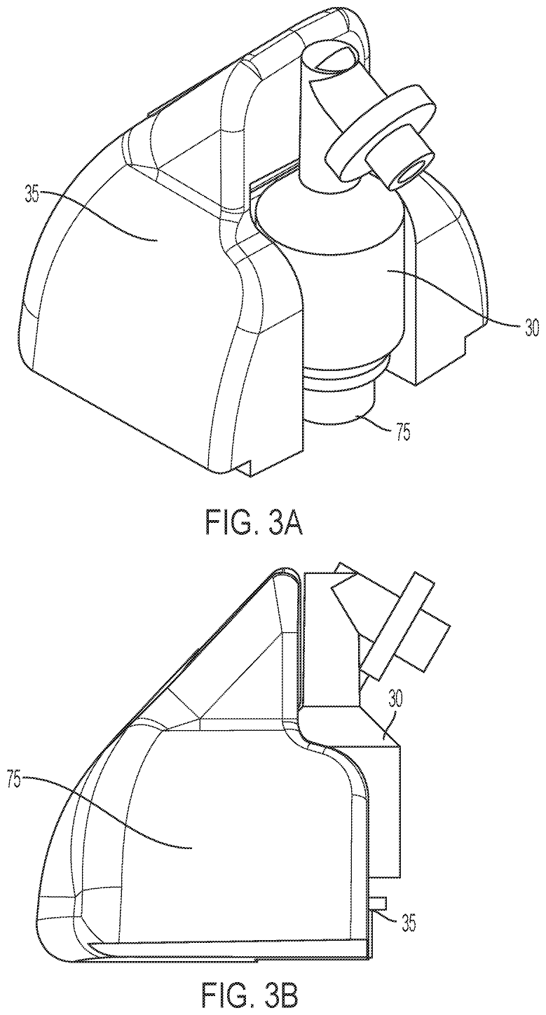

According to various embodiments, the spray head 10 includes an internal liquid reservoir 35 and dispenser 30 (shown in more detail in FIGS. 3A-3B). The internal liquid reservoir 35 and dispenser 30 are housed within the spray head 10. In some embodiments, the spray head 10 includes an outer housing and the internal liquid reservoir 35 and dispenser 30 are housed within the housing.

When the trigger 40 moves from the pulled position to the released position, the vacuum suction force causes a portion of the liquid within the internal reservoir 35 to be sucked through a channel 60 to the dispensing mechanism 30 and into the spray reservoir 15.

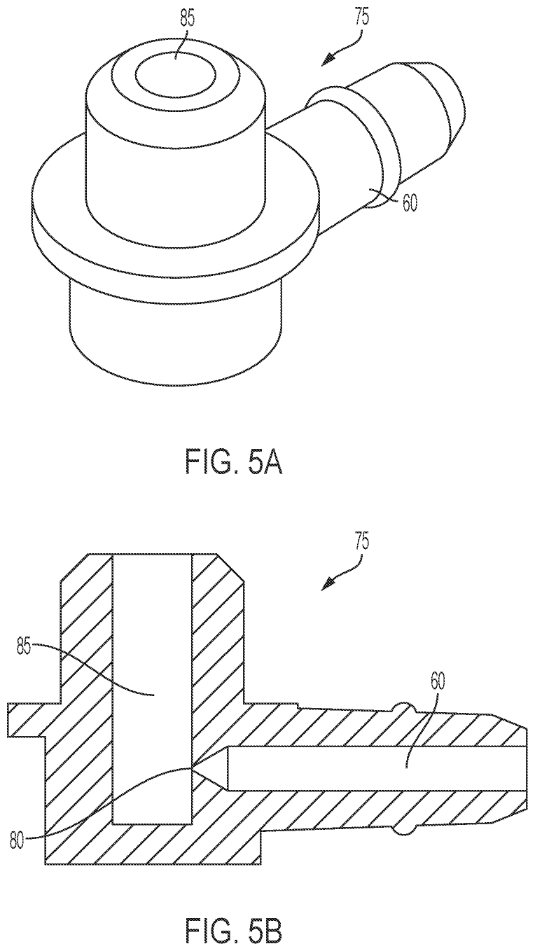

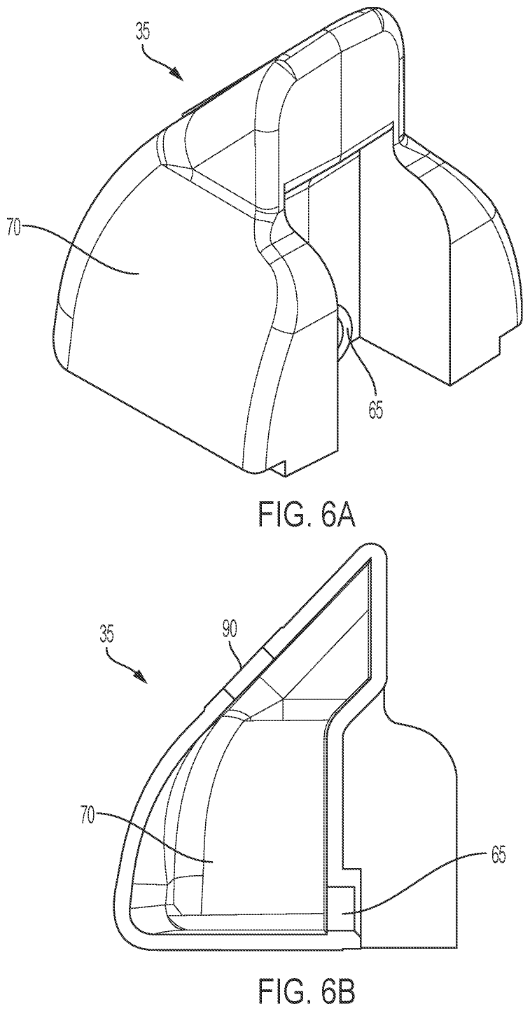

As shown in FIGS. 6A-6B, the internal reservoir 35 includes a storage chamber 70 for storing the liquid within the internal reservoir 35 and a port 65 through which the liquid moves from the storage chamber 70 to the channel 60. According to various embodiments, the channel 60 is a component of a measured liquid intake mechanism 75 (shown in more detail in FIGS. 5A-5B) configured to enable a measured volume of liquid to be sucked into the spray reservoir 15 from the internal liquid reservoir 35 when the trigger 40 moves from the pulled position to the released position. According to various embodiments, the measured volume results in a ratio in the spray reservoir of liquid form the internal reservoir 35 to liquid from the exterior reservoir (not shown). According to various embodiments, the ratio varies based on the concentration of the liquid in the internal reservoir 35 and the liquid in the exterior reservoir.

According to various embodiments, the channel 60 includes an opening 80 configured to limit the rate of flow of the liquid moving from the internal liquid reservoir 35 to the spray reservoir 15. According to some embodiments, the opening 80 has a smaller diameter than the channel 60. According to some embodiments, the internal liquid reservoir 35 includes a vent valve 90 for enabling air to enter into the internal liquid reservoir 35 as the liquid exits the internal liquid reservoir 35.

According to various embodiments, the ratio is affected by the diameter of the opening 80. According to various embodiments, the diameter of the opening 80 is approximately 0.5 mm. It is noted, however, that other diameters may be implemented (e.g., between 0.2 and 1.0 mm, or greater), while still maintaining the spirit and functionality of the present disclosure.

According to various embodiments, the measured liquid intake mechanism 75 is configured to dispense a volume of liquid from the internal liquid reservoir 35 pertaining to a range of mass per liquid volume dispensed from the exterior reservoir. For example, the ratio may be approximately 0.025-0.15 grams per fluid ounce of liquid from the exterior reservoir. It is noted, however, that other ratios may be implemented, depending on the properties of the fluid within the internal liquid reservoir 35 and the fluid within the exterior reservoir.

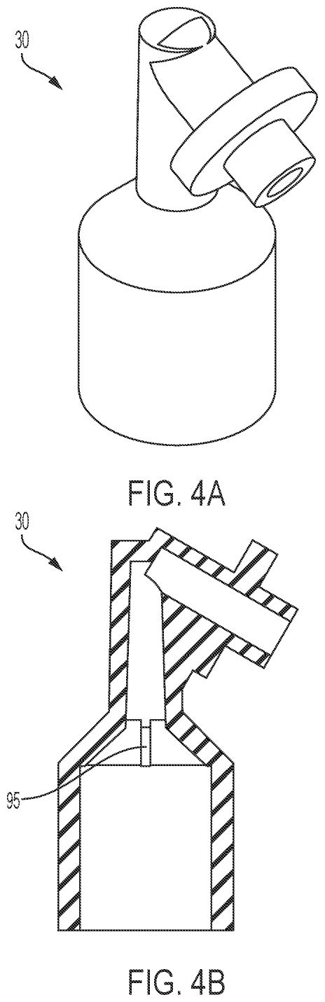

As shown in FIGS. 1 and 3A-3B, and in more detail in FIGS. 4A-4B, the spray head 10 includes an internal liquid dispenser 30 configured to transfer liquid from channel 60 to the spray reservoir 15. According to various embodiments, the internal liquid dispenser 30 includes a one-way valve 95 which enables liquid to be sucked into the spray reservoir 15 via the channel 60, but not to be pushed through the channel 60 from the spray reservoir 15. According to various embodiments, the one-way valve 95 is a ball valve. It is noted, however, that other suitable one-way valves may be used, while maintaining the spirit and functionality of the present disclosure.

According to various embodiments, the internal liquid reservoir 35 is configured to hold a liquid to be mixed with the liquid from the exterior reservoir prior to the mixture being expelled form the spray head 10 view the nozzle 20. For example, the internal liquid reservoir 35 may contain a perfume or deodorizer. If the liquid from the exterior liquid reservoir has an undesired or foul odor, the perfume or deodorizer can be mixed in with the liquid from the exterior liquid reservoir prior to spraying the liquid, decreasing or masking the odor form the exterior liquid reservoir. Additionally, since the internal liquid reservoir 35 is housed within the spray head 10, the spray head 10 can be switched from bottle to bottle (or other suitable exterior liquid reservoir) while maintaining the liquid within the internal liquid reservoir 35 between movements of the spray head 10.

The features and functions described above, as well as alternatives, may be combined into many other different systems or applications. Various alternatives, modifications, variations, or improvements may be made by those skilled in the art, each of which is also intended to be encompassed by the disclosed embodiments.

1. A spray head for spraying a liquid mixture, comprising:
a spray reservoir configured to hold the liquid mixture;
a channel configured to receive a first liquid into the spray reservoir from a source outside the spray head;
an internal liquid reservoir housed within the spray head, configured to hold a second liquid; and
a dispenser configured to dispense the second liquid from the internal liquid reservoir to the spray reservoir for mixing with the first liquid,
wherein the liquid mixture is a mixture of the first liquid and the second liquid.

2. The spray head of claim 1, further comprising:
a nozzle; and
a trigger mechanism configured to force the liquid mixture from the spray reservoir to an exterior of the spray head through the nozzle.

3. The spray head of claim 1, wherein:
the trigger mechanism is configured to be moved into a first position and a second position; and
movement of the trigger mechanism from the first position to the second position causes the vacuum suction force to pull the second liquid from the internal liquid reservoir to the spray reservoir.

4. The spray head of claim 3, further comprising a measured liquid intake mechanism configured to limit a volume of liquid that is pulled from the internal liquid reservoir to the spray reservoir when the trigger mechanism moves from the first position to the second position.

5. The spray head of claim 4, wherein:
the internal liquid reservoir includes a port through which the second liquid can flow; and
the measured liquid intake mechanism includes a channel having an opening to the port.

6. The spray head of claim 5, wherein:
the channel of the measured liquid intake mechanism has a first diameter;
the opening has a second diameter; and
the second diameter is smaller than the first diameter.

7. The spray head of claim 5, wherein the opening has a diameter of between 0.2 mm and 1.0 mm.

8. The spray head of claim 1, wherein the dispenser includes a one-way valve configured to enable liquid to move from the internal liquid reservoir to the spray reservoir but not from the spray reservoir to the internal liquid reservoir.

9. The spray head of claim 8, wherein the one-way valve is a ball valve.

10. The spray head of claim 1, wherein the internal liquid reservoir includes a vent valve positioned along an exterior of the spray head.

11. The spray head of claim 1, wherein the channel configured to receive the first liquid includes a one-way valve configured to enable liquid to move through the channel in a direction toward the spray reservoir, but not in an opposing direction.
